(19) United States
(12) Patent Application Publication
(10) Pub. No.: US 2013/0197724 A1
(43) Pub. Date: Aug. 1, 2013

(54) GUST COMPENSATED TOTAL ENERGY VARIOMETERS

(71) Applicant: David Miller Ellis, Warren, VT (US)

(72) Inventor: David Miller Ellis, Warren, VT (US)

(21) Appl. No.: 13/753,689

(22) Filed: Jan. 30, 2013

Related U.S. Application Data
(60) Provisional application No. 61/593,277, filed on Jan. 31, 2012.

(51) Int. Cl. B64D 45/00

(52) U.S. Cl. CPC B64D 45/00
USPC 701/6

(57) ABSTRACT

Rise and fall rates for a glider are determined based on the glider's angle of attack and speed. These rise and fall rates are used to compensate a variometer so that the impact of vertical airmass flow can be used to optimize glider soaring. Altitude measurements are used to determine the glider's potential energy while velocity is used to determine the glider's kinetic energy. Total energy compensation techniques are then used to correct error calculations in the variometer.

### RELATED APPLICATIONS

This application claims the benefit of U.S. provisional patent application “Gust Compensated Total Energy Variometers” Ser. No. 61/593,277, filed Jan. 31, 2012. The foregoing application is hereby incorporated by reference in its entirety.

### FIELD OF ART

This application relates generally to determining motion and more particularly to gust-compensated total energy variometers.

### BACKGROUND

Knowledge of rate-of-climb is critical to both powered and unpowered flight. In the case of glider flight, the pilot desires to sustain motor-less flight; so he or she requires near-instantaneous evaluation of rate-of-climb. During powered flight, the pilot may use a vertical speed indicator, also called a variometer, to maintain level flight. Gliders may use a vertical speed indicator, or variometer, to indicate aircraft vertical motion. A simple type of variometer requires no external power supply, may be hand held, and is primarily used during flight rather than during landing or takeoff. Use of a variometer is critical since humans have difficulty sensing climb or sink rates—a human can detect abrupt changes in altitude, but not a subtle climb or sink rate. Without such a device, it is very difficult for glider pilots to sustain flight. Visual determination of climb or sink rate relative to a fixed reference such as a hillside or the ground is possible, but not generally useful.

Devoid of an engine, a glider pilot seeks rising air to sustain flight. Historically, glider variometers were based on direct measurements of changes in static pressure of the atmosphere. Measured changes in atmospheric pressure correspond to changes in altitude. As glider performance improved, pilots found that small fore or aft control stick motion made the variometer reading swing wildly. Because an aerodynamically efficient glider rises quickly when the pilot pulls back on the stick, the variometer response to this overwhelms its response to air mass motion.

Thus, in order for a pilot to gauge vertical speed of a thermal air mass independent of pilot action, a total energy (TE) compensation technique may be employed. A total energy variometer displays the rate-of-change of the glider's total energy rather than only potential energy.

### SUMMARY

Knowledge of rate of climb is critical to both powered and unpowered flight. Total energy variometers display rate-of-change in glider total energy, eliminating changing variometer response to pilot input. Total energy variometers respond to air mass gusts, thus limiting their ability to respond rapidly to useful air mass motion. A processor implemented method for analyzing motion is disclosed comprising: determining a first altitude for an aircraft; calculating a potential energy for the aircraft based on the first altitude; determining a velocity for the aircraft; calculating a kinetic energy for the aircraft based on the velocity; determining a first angle for the aircraft based on pointing direction of the aircraft relative to a pitch axis for the aircraft; determining a second angle for the aircraft, relative to the pitch axis, such that when the first angle equals the second angle there is no transfer of energy between potential energy and kinetic energy; and calculating a first altitude-change rate for the aircraft based on the velocity and a difference between the first angle and the second angle. The method may further comprise calculating a pitch-compensated altitude-change rate wherein the pitch-compensated altitude-change rate includes a difference between the first altitude-change rate and an altitude change rate based on changes in static pressure. The method may further comprise presenting the pitch-compensated altitude-change rate. The presenting may be accomplished with a visual display. The presenting may be accomplished with audio tones. The calculating of the pitch-compensated altitude-change rate may be further based on an acceleration along a vertical axis of the aircraft. The acceleration may be measured using an accelerometer. The velocity, used in the calculating of the first altitude-change rate, may be modified to compensate for an exchange between the kinetic energy and the potential energy of the aircraft. The method may further comprise determining a total-energy compensated altitude-change rate based on a total energy for the aircraft. The total energy of the aircraft may comprise a sum of the potential energy and the kinetic energy. The method may further comprise averaging the total-energy compensated altitude-change rate to determine an average total-energy compensated altitude-change rate. The averaging for the average total-energy compensated altitude-change rate may be over a period of time that is substantially 30 seconds. The method may further comprise computing an average for the first altitude-change rate to provide an averaged value. The averaging of the total-energy compensated altitude-change rate and computing the averaged value for the first altitude-change rate may be both over a period of time that is substantially 30 seconds.

The method may further comprise computing a difference between the average total-energy compensated altitude-change rate and the averaged value for the first altitude-change rate. The method may further comprise computing a correction to the second angle that minimizes the difference between the average total-energy compensated altitude-change rate and the averaged value for the first altitude-change rate. The correction may be further based on an instantaneous lift coefficient. A measurement for the first altitude may be based on measurement of static air pressure. The aircraft may be a motor-less aircraft. The velocity of the aircraft may be determined based on measured pitot air pressure and static air pressure. The determining the second angle may be based on a mass of the aircraft and an area of a wing on the aircraft. The determining the second angle may be based on the velocity of the aircraft which is recalculated on an instantaneous basis. The method may further comprise calculating a total energy for the aircraft where the total energy is a sum of the potential energy and the kinetic energy. The method may further comprise calculating an average total energy over a period of time and using the average total energy in the determining of the second angle. The first altitude-change rate may be corrected for a roll-axis bank angle of the aircraft. The roll-axis bank angle may be measured with a roll-axis rate gyro. The first altitude-change rate may be corrected for increased angle of attack due to aircraft rotational acceleration. The aircraft rotational acceleration may be computed from yaw axis acceleration and roll-axis angle.

In some embodiments, an apparatus for analyzing motion may comprise a pressure sensor used in determining an altitude for an aircraft; one or more sensors used in determining a velocity for the aircraft; a pitch angle sensor for determining a first angle for the aircraft; and one or more processors that: calculate a kinetic energy for the aircraft based on the velocity; calculate a potential energy for the aircraft based on the altitude; determine a second angle for the aircraft, relative to pitch axis, such that when the first angle equals the second angle there is no transfer of energy between potential energy and kinetic energy; and calculate a first altitude-change rate for the aircraft based on the velocity and a difference between the first angle and the second angle. In embodiments, a system for analyzing motion may comprise: a pressure sensing means for determining an altitude for an aircraft; a velocity sensing means for the aircraft to determine velocity; a pitch angle sensing means for determining a first angle for the aircraft; and a processing means to: calculate a kinetic energy for the aircraft based on the velocity; calculate a potential energy for the aircraft based on the altitude; determine a second angle for the aircraft, relative to pitch axis, such that when the first angle equals the second angle there is no transfer of energy between potential energy and kinetic energy; and calculate a first altitude-change rate for the aircraft based on the velocity and a difference between the first angle and the second angle. In some embodiments, a computer program product embodied in a non-transitory computer readable medium for analyzing motion may comprise: code for determining a first altitude for an aircraft; code for calculating a potential energy for the aircraft based on the first altitude; code for determining a velocity for the aircraft; code for calculating a kinetic energy for the aircraft based on the velocity; code for determining a first angle for the aircraft based on pointing direction of the aircraft relative to a pitch axis for the aircraft; code for determining a second angle for the aircraft, relative to the pitch axis, such that when the first angle equals the second angle there is no transfer of energy between potential energy and kinetic energy; and code for calculating a first altitude-change rate for the aircraft based on the velocity and a difference between the first angle and the second angle.

In embodiments, a processor implemented method for analyzing motion may comprise: determining an altitude for an aircraft; calculating a potential energy for the aircraft based on the altitude; determining a horizontal velocity for the aircraft wherein the horizontal velocity is determined with a GPS receiver; compensating the horizontal velocity for the aircraft for wind speed, wherein the wind speed is calculated using pitot pressure, to produce a compensated velocity; calculating a horizontal kinetic energy for the aircraft based on the compensated velocity; calculating a change in the altitude based on air pressure; calculating an instantaneous vertical kinetic energy based on the change in the altitude; calculating a total energy wherein the total energy is a sum of the horizontal kinetic energy, the instantaneous vertical kinetic energy, and the potential energy; calculating a total-energy compensated altitude-change rate based on the total energy; and presenting the total-energy compensated altitude-change rate.

Various features, aspects, and advantages of numerous embodiments will become more apparent from the following description.

### BRIEF DESCRIPTION OF THE DRAWINGS

The following detailed description of certain embodiments may be understood by reference to the following figures wherein:

FIG. 1 is a flow diagram for pitch compensation.

FIG. 2 is a flow diagram for computing correction.

FIG. 3 is flow diagram for altitude change rate determination with a GPS.

FIG. 4 is a diagram showing glider angles.

FIG. 5 is a diagram showing altitude changes.

FIG. 6 is a system diagram for variometer.

FIG. 7 is a system diagram for variometer using a GPS.

### DETAILED DESCRIPTION

The present disclosure provides a description of various methods, systems, and apparatus associated with total energy variometers. Knowledge of an aircraft's rate-of-climb is critical to both powered and unpowered, i.e. glider, flight. Particularly for sustained glider flight, the pilot desires to soar and therefore requires near-instantaneous reading of his or her aircraft's rate of climb or descent rather than a rate averaged over time. A variometer may indicate the climb or sink of an aircraft, but not account for the behavior of turbulent, gusty air masses of a thermal in isolation. A typical response by a total energy variometer to gusts provides an inability to rapidly identify those parts of a rising air mass that sustain flight. Uncompensated variometers do not take into account changes in altitude due exclusively to changes in speed of the aircraft where height changes are inversely proportional to velocity squared changes. Thus, in order for a pilot to adequately gauge vertical speed of a thermal, independent of speed change, a total energy compensation technique may be employed.

Modern motorless aircraft, known as gliders, typically have wing loading values of 40 Kg/m², and fly at 25 meters per second (m/s) while sinking in still air at only 0.5 m/s. Sustained flight times and distances require an instrument known as a variometer (Vario) capable of displaying changes of less than 0.1 m/s in the vertical component of air mass motion. A glider's total energy is the sum of potential energy (M*g*H) and kinetic energy (0.5*M*V²) where M=glider mass, g=gravitational acceleration, H=altitude, and V=airspeed. By pulling back on the control stick, the glider pilot converts kinetic energy to potential energy, rendering a variometer sensing only potential energy (altitude) changes which, in isolation, are useless for glider flight. Previous total energy variometers sense changes in total energy that are conserved in pilot-controlled maneuvers but are sensitive to short-term changes in kinetic energy as the glider flies through gusts.

Theory predicts, and detailed experiments verify, that airspeed-sensed gusts account for more than 80% of the variometer-displayed signal in typical thermal conditions for a typical glider (as defined above). The remainder of the gust-related displayed signal comes from yaw-axis force created by the gust acting on the glider wing.

Gust sensitivity limits the response speed of a total energy compensated variometer and its value in optimizing glider climb rate in thermals. Two methods of gust compensation in a total energy variometer are disclosed:
1. A pitch-compensated total energy variometer uses instantaneous change in glider pitch angle to compute potential energy changes caused by pilot action.
   A glider fuselage pitch angle, at which no exchange takes place between kinetic and potential energy, is a function of: a. Wing camber as controlled by flap position, b. Wing loading as a function of ballast and bank angle in circling flight, c. Average measured airspeed through the heuristic lift coefficient equation, and d. Pitch rate sensor zero offset error. Means are required to correct these errors in computation of kinetic energy changes based upon glider pitch angle.
   A pitch-compensated total energy variometer computes the difference between average total-energy compensated variometer readings and average pitch-compensated variometer values. The difference is fed back as an adjustment to glider fuselage measured pitch angle. The adjustment is based on average values, whereas short-term changes in measured pitch angle are used in computing the kinetic energy change that results from pilot-induced pitch change. Because glider total energy is conserved, the altitude change caused by this pitch change can be computed and removed from altitude change due to vertical air mass motion. A pitch-compensated variometer therefore has the long-term accuracy of a total energy compensated variometer while eliminating useless total energy changes arising from gusts that cause short term fluctuations in kinetic energy.
2. A GPS-compensated total energy variometer uses GPS groundspeed, corrected for average wind strength and direction, to compute ground-referenced instantaneous airspeed.
   Unlike direct, instantaneous airspeed measurements, ground-referenced instantaneous airspeed ignores short-term air mass turbulence. The GPS-compensated total energy variometer display is computed as the time derivative of total energy defined as the sum of potential energy and ground-referenced kinetic energy computed from the GPS ground speed.

A gust-compensated total-energy variometer as disclosed herein may utilize pitch, GPS-compensation, or any combination thereof to reduce the deleterious effects of gusts on the variometer display.

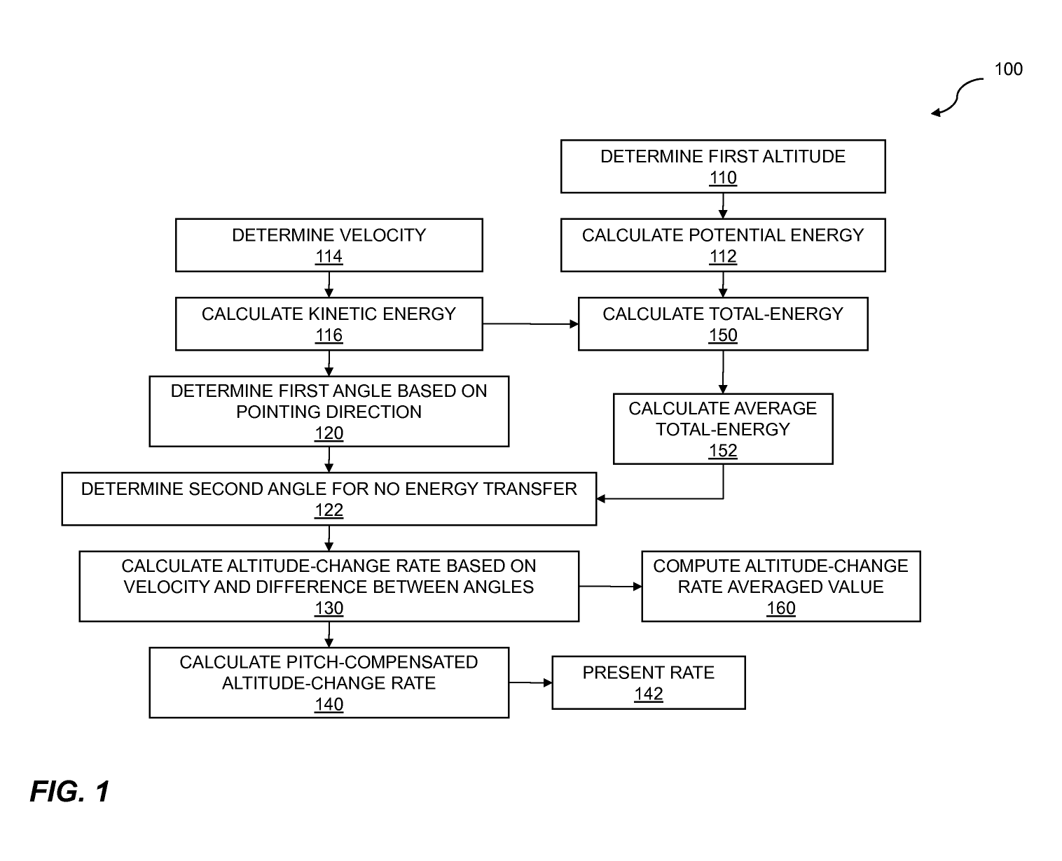

FIG. 1 is a flow diagram for pitch compensation. A flow 100 describes a processor-implemented method for analyzing motion. With knowledge of aircraft altitude, velocity, kinetic energy, potential energy and various angles, compensation can be performed to isolate the rise or sink speed of the thermal, independent of the climb or dive rate of the aircraft.

An aircraft pilot requires critical, detailed information about rate of climb or descent of the aircraft. During powered flight, the pilot uses a vertical speed indicator (VSI) to maintain level during specific maneuvers—while turning, for example. Gliders use a VSI or variometer almost continuously to try to determine whether the glider is in a thermal and if the air in the thermal is rising or sinking Gliders may be equipped with one or more variometers. A simple variometer requires no external power supply and may be handheld. More complex variometers require an external power source and various inputs. A variometer is primarily used during flight rather than during landing or takeoff. Glider pilots may use variometers to prevent releasing a glider from a tow plane while the glider is sinking Use of an accurate variometer is critical since humans can detect abrupt changes in altitude, but cannot well sense climb or sink rates of an aircraft. Without such a device, it is very difficult for glider pilots to soar. Though visual determination of climb or descent relative to a fixed reference such as a hillside, building, or the ground is possible in some situations, such visual determination is not generally optimal.

Simple, uncompensated variometer devices lack the ability to determine the vertical speed of an air column in isolation and are therefore not overly useful during glider flight. That is, the rise or sink rate changes of air shown by the uncompensated variometer are confounded by rise or fall of the aircraft rather than solely rising or sinking of air in isolation. This effect is sometimes referred to as a so-called “stick thermal”. A glider pilot is particularly interested in the rate of climb of air in a thermal. An uncompensated variometer indicates climb or sink of an aircraft, but not the rate of climb or sink of a thermal because indication by the variometer is based on changes in atmospheric pressure. Uncompensated variometers do not take into account changes in altitude due exclusively to changes in speed of the aircraft (noting that height of the aircraft Δ h is inversely proportional to velocity squared of the aircraft Δv). In some variometers, measured airflow in a tube may be caused by changes in altitude. Airflow direction may also be measured to determine whether the aircraft is in a climb or in a descent. Many modern variometer devices may determine altitude by directly measuring the static pressure of the atmosphere. The actions of an aircraft climbing or diving impact the speed of the aircraft. For example, pulling up to enter a thermal or diving to exit a sink area causes a change in altitude linked to a change in aircraft velocity, thus obscuring any attempt to determine the vertical movement of the air mass. A glider may gain altitude but lose forward speed, or gain forward speed but lose altitude. In other words, the glider may exchange potential energy for kinetic energy, or kinetic energy for potential energy. Total energy (TE) is the sum of the potential energy (PE) and the kinetic energy (KE). Thus by knowing altitude, velocity, kinetic energy, potential energy, various angles, and the like, compensation can be performed by an advanced variometer to isolate the rise or sink speed of the thermal air independent of the climb or dive of the aircraft.

The flow 100 may begin with determining a first altitude for an aircraft 110. Various means may be used to determine the first altitude of the aircraft. These means may include but are not limited to Pitot tubes, electronic sensors, GPS devices, and the like. Any of these or other means may be used to determine the first altitude of the aircraft.

The flow 100 may continue with calculating a potential energy 112 for the aircraft based on the first altitude. Potential energy is proportional to the altitude of the aircraft and may be calculated as the mass of the aircraft multiplied by the gravitational constant multiplied by the aircraft's altitude. Having determined the first altitude, one may determine a potential energy value. The potential energy value may be determined by calculation, a lookup table, and the like.

The flow 100 may continue with determining a velocity 114 for the aircraft. Various means may be used to calculate aircraft velocity including but not limited to a Pitot airspeed indicator, a lift reserve indicator (LRI), and the like. Any of these or other means may be used to determine the velocity of the aircraft.

The flow 100 may continue with calculating a kinetic energy 116 for the aircraft based on the aircraft's velocity. Kinetic energy is proportional to the velocity squared of the aircraft. Having determined the aircraft's velocity, one may determine a value for kinetic energy. The kinetic energy value may be determined by calculation, a lookup table, and the like.

The flow 100 may continue with determining a first angle for the aircraft based on pointing direction 120 of the aircraft relative to a pitch axis for the aircraft. Various methods may be used to calculate the first angle of the aircraft based on pointing direction and pitch axis. Such methods may include, but are not limited to, tilt sensing, inclination, and the like. For example, tilt may be measured by any means including liquid capacitive, electrolytic, and the like.

The flow 100 may continue with determining a second angle for the aircraft 122, relative to the pitch axis, such that when the first angle equals the second angle there is no transfer of energy between potential energy and kinetic energy. This second angle may be a point where horizontal velocity is maintained. However, flight will not be perfectly horizontal due to friction as the glider passes through the air and may be as small as a fraction of a degree below horizontal. The angle at which a glider's potential and kinetic energy do not undergo exchange is relevant to compensation of a variometer. Further, this particular angle may change during flight. The determining the second angle is based on a mass of the aircraft and an area of a wing on the aircraft. In some embodiments, the second angle depends on airspeed, camber, temperature, and the like. The determining of the second angle may be recalculated on an instantaneous basis.

The flow 100 may continue with calculating a first altitude-change rate 130 for the aircraft based on the velocity and a difference between the first angle and the second angle. When the first angle is below the second angle, it will be considered a negative difference. This negative difference will result in the glider gaining horizontal velocity and losing altitude. A positive difference occurs when the first angle is above the second angle. This positive difference will result in the glider losing horizontal velocity and gaining altitude. The losing or gaining altitude will determine the first altitude-change rate.

The flow 100 may also include computing an average for the first altitude-change rate 160 to provide an averaged value. The altitude-change rate may be averaged to negate minor perturbations that would confuse the pilot. Various means may be used to determine a first altitude-change rate, including computation, table lookup and the like. Averaging the first altitude-change rate to determine an averaged value may be accomplished through various means. In some embodiments, the velocity, used in the calculating of the first altitude-change rate, may be modified to compensate for an exchange between the kinetic energy and the potential energy of the aircraft. Over time as a glider climbs, the glider decelerates in the horizontal direction resulting in a changing horizontal velocity. Therefore the changing horizontal velocity may in turn be used to determine the changing vertical velocity as kinetic energy is traded for potential energy. Over time as a glider descends, the glider accelerates in the horizontal direction resulting in a changing horizontal velocity. Likewise, therefore, the changing horizontal velocity may be used to determine the changing vertical velocity as kinetic energy is traded for potential energy.

The flow 100 may include calculating a total energy 150 for the aircraft where the total energy is a sum of the potential energy and the kinetic energy. Total energy (TE) is determined by summing potential energy (PE) and kinetic energy (KE). Total energy is determined as part of the compensation process to isolate rise or fall of air in a thermal from rise or fall of an aircraft. Due to conservation of energy, total energy is maintained and therefore variometers have used total energy to compensate. The problem is that historically this compensation has been too slow to effectively use a rising air mass to gain soaring altitude.

The flow 100 may include calculating an average total energy 152 over a period of time using the average total energy in the determining of the second angle. The total energy could not be instantaneously calculated in a useful way due to turbulence which would throw off the total energy calculation. Therefore the average total energy was calculated. This average total energy is still extremely useful in calculating the second angle where there is no tradeoff between potential energy and kinetic energy. The average total energy calculation can be used to prevent accumulating error over time.

The flow 100 may continue with calculating a pitch-compensated altitude-change rate 140 wherein the pitch-compensated altitude-change rate includes a difference between the first altitude-change rate and an altitude change rate based on changes in static pressure. The altitude-change rate based on static pressure will provide a measurement of the rise or fall of the glider. The first altitude-change rate is based on the horizontal velocity and the angle at which the glider is traveling. By taking the difference between these two altitude-change rates, the real change due to the motion of the air mass through which the glider is traveling can be determined.

The flow 100 may continue with presenting the pitch-compensated altitude-change rate 142. The pilot needs to be made aware of the pitch-compensated altitude-change rate and this pitch-compensated altitude-change rate can be presented in either a visual or audio fashion. The presenting may be accomplished with a visual display. The visual display may comprise any of a number of devices including an LCD display, a plasma display, a video display, a handheld display, a PDA display, a heads up display, a tablet display and the like. Further, the presenting may be accomplished with audio tones. The audio tones may be delivered by any of a number of transducers including earphones, headphones, wireless earphones, wireless headphones, portable speakers, built in speakers, and the like. The audio tones may change in frequency, in rate of repetition, or a combination thereof

The flow 100 may include averaging the total-energy compensated altitude-change rate to determine an average total-energy compensated altitude-change rate. The flow 100 may also include averaging a pitch-compensated altitude-change rate. The total-energy compensated altitude change rate is the altitude change rate that has been used in recent history and on which the disclosed concept provides significant improvement upon. A comparison may be made between the pitch-compensated altitude-change rate and the average total-energy compensated altitude-change rate. In embodiments, differences between the rates can be identified and errors reduced over time. The averaging for the average total-energy compensated altitude-change rate may be over a period of time that is substantially 30 seconds. The averaging of the total-energy compensated altitude-change rate and the computing the averaged value for the first altitude-change rate may both be over a period of time that is substantially 30 seconds. Various steps in the flow 100 may be changed in order, repeated, omitted, or the like without departing from the disclosed inventive concepts. Various embodiments of the flow 100 may include a computer program product embodied in a non-transitory computer readable medium that includes code executable by one or more processors.

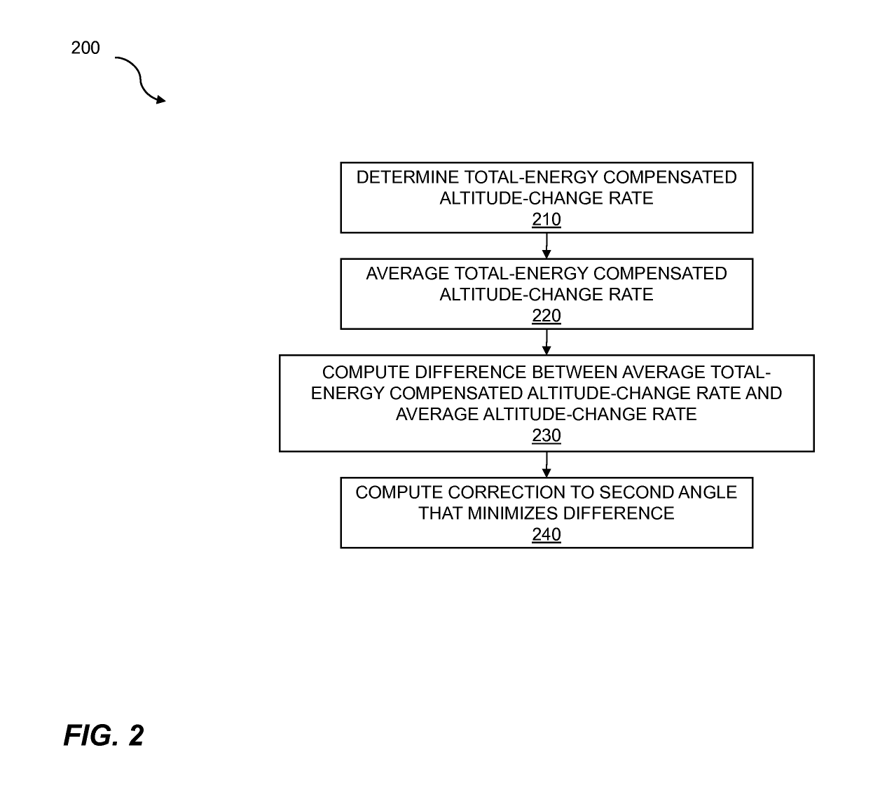

FIG. 2 is flow diagram for computing correction. A processor implemented flow 200 is described based on a total-energy compensated altitude-change rate to compute a correction to an angle at which there is no tradeoff between potential energy and kinetic energy. This angle is referred to as the second angle in FIG. 1. The flow 200 may begin with determining a total-energy compensated altitude-change rate 210 as described for FIG. 1. Based on the determining of a potential energy and kinetic energy, a total energy may be found. Using the calculated total energy, a total energy-compensated altitude-change rate may be found. Over time, an average total-energy compensated altitude-change rate 220 may be determined. The amount of time over which an average total-energy compensated altitude-change rate may be determined may be a fraction of a second, a second, a few seconds, 15 seconds, 30 seconds, or any other time deemed appropriate for the purposes of averaging glider flight. The flow 200 may continue with computing a difference between the average total-energy compensated altitude-change rate and the averaged value for the first altitude-change rate 230. The flow 200 may continue by computing a correction to the second angle that minimizes the difference 240 between the average total-energy compensated altitude-change rate and the averaged value for the first altitude-change rate. The correction value may be calculated by a variety of means that may include but are not limited to computation, table lookup, and the like. The flow 200 may also include a correction wherein the correction is further based on an instantaneous lift coefficient. Various steps in the flow 200 may be changed in order, repeated, omitted, or the like without departing from the disclosed inventive concepts. Various embodiments of the flow 200 may include a computer program product embodied in a non-transitory computer readable medium that includes code executable by one or more processors.

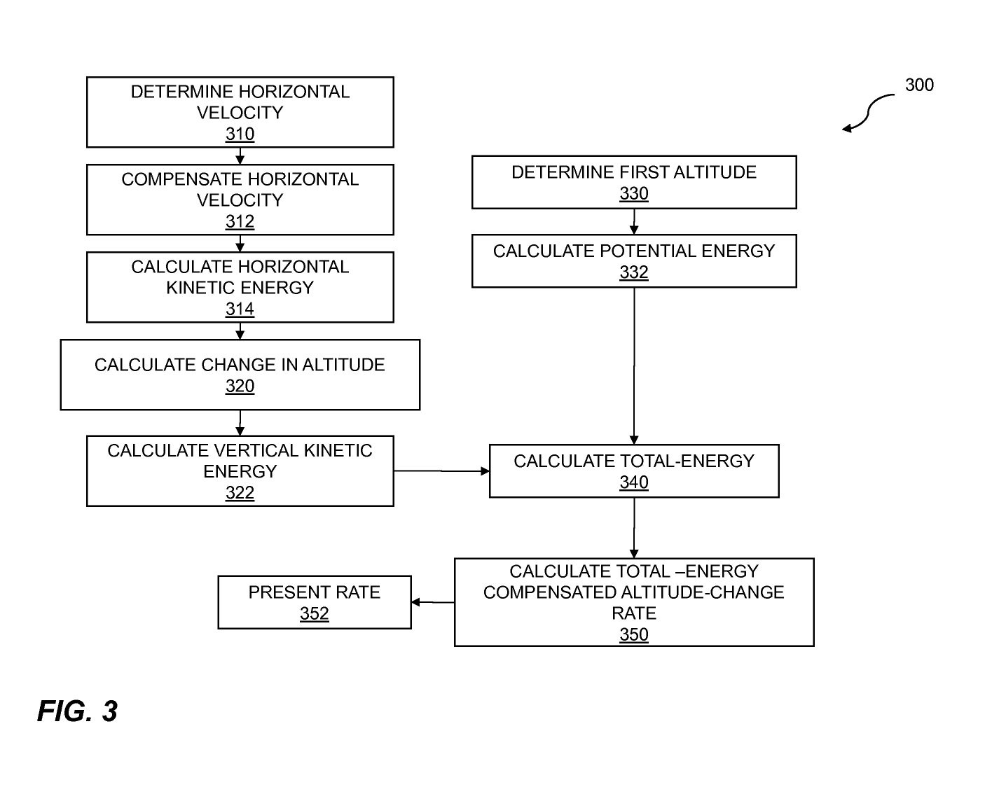

FIG. 3 is a flow diagram for altitude-change rate determination with a GPS receiver. A processor-implemented flow 300 is described in which a total-energy compensated altitude-change rate is calculated. The flow 300 may begin by determining the horizontal velocity 310 of an aircraft. The horizontal velocity may be determined by a variety of means including using air pressure, a GPS receiver, and the like. The flow 300 may continue by determining a compensated horizontal velocity 312. If the horizontal velocity that was determined is accurate enough then no compensation may be necessary. In many embodiments, compensation is required based on wind strength and direction. The wind strength and direction may be determined based on information relayed from the ground. The wind strength and direction may be based on GPS readings used in combination with air pressure readings. Further, the wind strength and direction may be based on the GPS ground speed, a GPS track, pneumatic air speed, magnetic aircraft heading, and the like. The wind strength and direction may be computed and averaged over a period of time between 15 and 30 seconds.

The flow 300 may continue by calculating horizontal kinetic energy 314. The kinetic energy can be calculated using the compensated horizontal velocity. In embodiments, the instantaneous horizontal component of the kinetic energy may be calculated using the instantaneous GPS groundspeed corrected for the average wind speed and direction. The flow 300 may continue by calculating change in altitude 320. The change in altitude may be determined from a GPS receiver, static air pressure, and the like. The flow 300 may continue by calculating vertical kinetic energy 322. The vertical kinetic energy is based on the change in altitude over a period of time. A compensated kinetic energy may be determined from instantaneous pneumatic airspeed readings.

The flow 300 may include determining a first altitude 330. Various means may be used to determine the first altitude of the aircraft. These means may include but are not limited to Pitot tubes, electronic sensors, GPS sensors, and the like. The flow 300 may continue by calculating a potential energy 332 where the potential energy may be found from a first altitude.

The flow 300 may continue by calculating a total energy for an aircraft 340. The total energy of the aircraft comprises a sum of the potential energy and the kinetic energy. The flow 300 may continue by determining a total-energy compensated altitude-change rate based on a total energy for the aircraft 350. The aircraft's instantaneous GPS-compensated total energy may comprise the sum of horizontal and vertical components of kinetic energy added to the potential energy as measured by either pressure-determined or GPS-determined altitude calculations.

The flow 300 may continue by presenting the altitude-change rate 352. The presenting may be accomplished by a visual display or an audio sound. The visual display may comprise any of a number of devices including an LCD display, a plasma display, a video display, a handheld display, a PDA display, a heads up display, a tablet display and the like. Likewise, the presenting may be accomplished with audio tones. The audio tones may be delivered by any of a number of transducers including earphones, headphones, wireless earphones, wireless headphones, portable speakers, built in speakers, and the like. Various steps in the flow 300 may be changed in order, repeated, omitted, or the like without departing from the disclosed inventive concepts. Various embodiments of the flow 300 may include a computer program product embodied in a non-transitory computer readable medium that includes code executable by one or more processors.

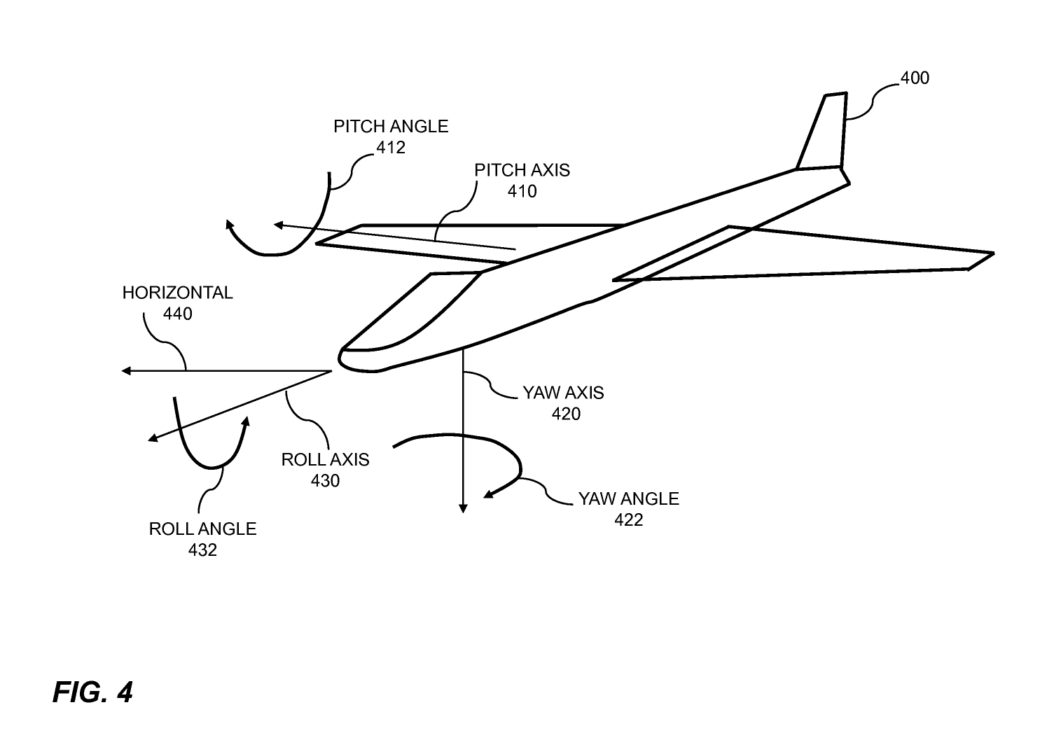

FIG. 4 is a diagram showing glider angles. Various angles are described for an aircraft 400. A glider 400 has a pitch axis 410, a yaw axis 420, and roll axis 430. The glider 400 can rotate about any or all of these three axes. When the glider 400 rotates about the pitch axis 410, the glider 400 changes pitch angle 412. When the glider 400 rotates about the yaw axis 420, the glider 400 changes yaw angle 422. When the glider 400 rotates about the roll axis 430, the glider 400 changes roll angle 432. An arbitrary aircraft 400 is shown. The aircraft may be a motor-less aircraft. The pitch angle 412 may describe the angle of attack. The yaw angle 422 may define the aircraft's heading. The roll angle 432 may refer to a bank angle. Various methods may be used to calculate the first angle of the aircraft based on pointing, direction, and orientation. Such methods may include but are not limited to tilt sensing, accelerometers, gyros, inclination, and the like. The angle at which the potential energy and the kinetic energy of a glider are not exchanged is of interest to compensation of a variometer. This particular angle may change during flight. The angle is dependent upon airspeed, aircraft mass, and the like.

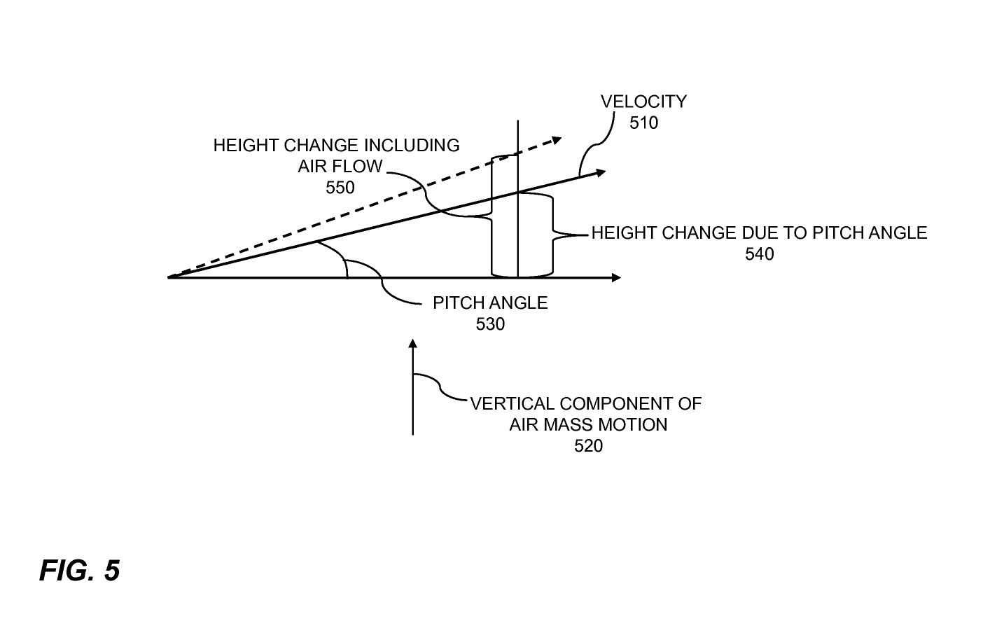

FIG. 5 is a diagram showing altitude changes in light of various angles relating to an aircraft. The aircraft may be traveling with a velocity 510. The aircraft may have a pitch angle 530 relative to level flight. When the aircraft travels with a velocity 510 along pitch angle 530, the aircraft goes through a height change 540 due to the pitch angle. The height 540 can be described according to the equation:

h=V*Sin(θ)

where h is the height 540, V is the velocity 510, and θ is the pitch angle 530.

The aircraft may be traveling through the air where the air is in motion and the air has a vertical component of the air mass motion (VCAM) 520. As a result of the aircraft traveling through the air mass, the aircraft may undergo a height change 550 which includes a height change due to the VCAM 520. The difference between the height 540 and the height change including air flow 550 is the altitude change due to the VCAM 520. This difference is the key value detected by the disclosed pitch compensated variometer and is described as the pitch-compensated altitude-change rate. The actions of an aircraft climbing or diving affect the speed of the aircraft. Pulling up to enter a thermal or diving to exit a sink area includes a change in altitude due to the change in aircraft velocity, thus obscuring the reading of the vertical speed of the air mass. That is, a glider may exchange height for speed or speed for height. In other words, the glider may exchange potential energy for kinetic energy. The key to soaring is identifying aircraft motion due to the VCAM 520. The calculating the pitch-compensated altitude-change rate is further based on an acceleration along a vertical axis of the aircraft. When a glider's stick or yoke is adjusted, the pointing angle of the glider does not instantaneously change. Instead, accelerometers may be used to sense attitude change for a glider. This change can be factored into the pitch-compensated altitude-change rate calculation.

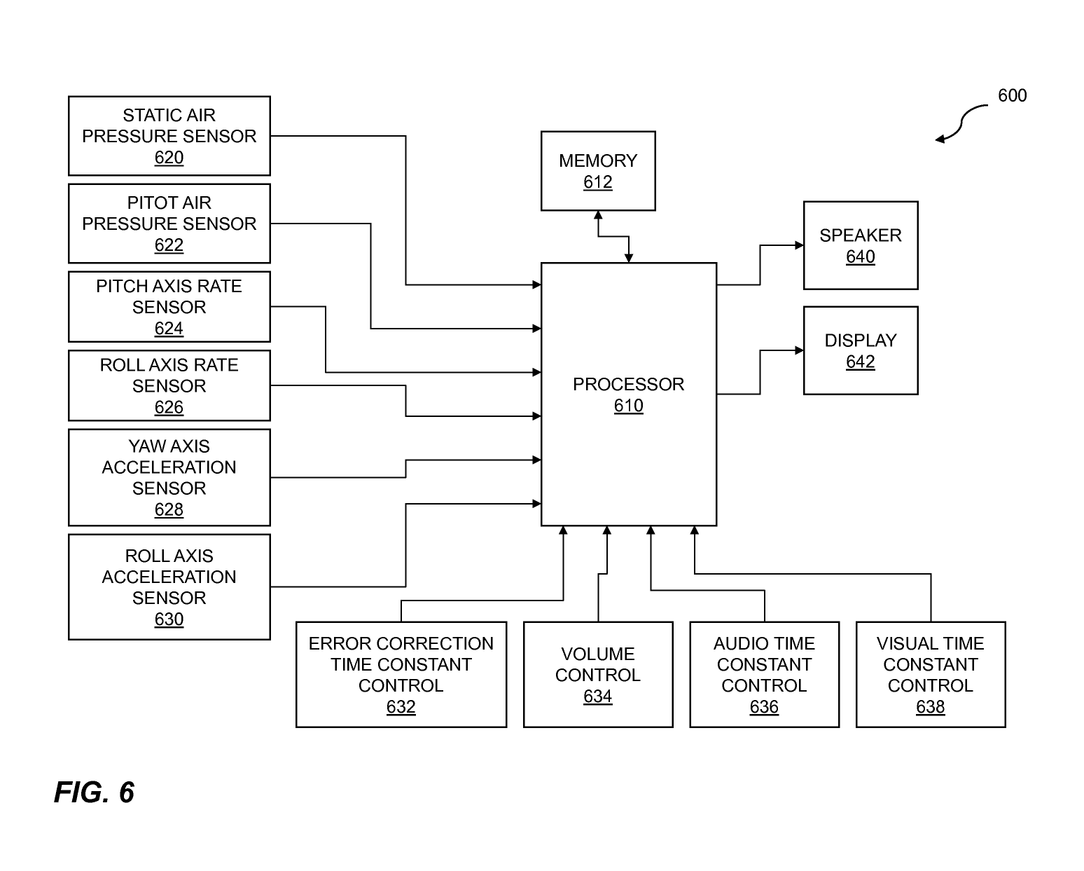

FIG. 6 is a system diagram for a variometer. A system 600 may include a processor 610 and a memory 612. The processor 610 may be one or more processors attached to the memory 612. The one or more processors 610 may execute instructions stored in the memory 612. The memory 612 may be used for storing instructions, for temporary data storage, for system support, and the like. The memory 612 may be comprised of one or more memories. The memory 612 may include a non-transitory computer readable medium with computer program product for analyzing motion.

The system 600 may further comprise a static air pressure sensor 620 for determining an altitude for an aircraft. The system 600 may also include a pitot air pressure sensor 622 for the aircraft. The system 600 may include a pitch axis rate sensor 624 for determining a pitch angle for the aircraft. The system 600 may include a roll axis rate sensor 626. The roll axis rate sensor 626 may be used to correct the pitch angle at which there is no exchange between kinetic energy and potential energy. The system 600 may include a yaw axis acceleration sensor 628. The yaw axis rate acceleration sensor 628 may be used to correct the pitch angle at which there is no exchange between kinetic energy and potential energy. The system 600 may further include a roll axis acceleration sensor 630. The roll axis acceleration sensor 630 may be used to further correct the pitch angle at which there is no exchange between kinetic energy and potential energy.

The one or more processors 610 may be used to calculate a kinetic energy for the aircraft based on the velocity. The one or more processors 610 may calculate a potential energy for the aircraft based on the altitude. The one or more processors 610 may determine an angle for the aircraft, relative to the pitch axis, such that there is no transfer of energy between potential energy and kinetic energy. The one or more processors 610 may calculate a first altitude-change rate for the aircraft based on the velocity and a difference between the pointing direction of the glider and this angle.

The one or more processors 610 may determine total-energy compensated altitude-change rate, kinetic energy, potential energy, change in altitude, vertical kinetic energy, various angles, and the like. The altitude-change rate may be corrected for a roll-axis bank angle of the aircraft. The roll-axis bank angle may be measured with a roll-axis rate gyro. The first altitude-change rate may be corrected for increased aircraft angle of attack due to an aircraft's rotational acceleration. The system 600 may include a yaw axis acceleration sensor 628. The acceleration along the yaw axis 628 may be measured using an accelerometer. The aircraft rotational acceleration may be computed from aircraft yaw axis acceleration and roll-axis angle. The system 600 may include a roll axis acceleration sensor 630. The acceleration along the roll axis 630 may be measured using an accelerometer.

The system 600 may include a speaker 640 for outputting audio tones. The speaker may be earphones, headphones, wireless earphones, wireless headphones, portable speakers, built in speakers, and the like. The system 600 may have a display 642 which provides visual output for the variometer. The display 642 may be used to provide information from the processor 610, video data, instructions, warnings, and the like. The display 642 may be an LCD display, a laptop display, a tablet display, a handheld display, a PDA display, or any other suitable display.

The system 600 may include a control for error correction with a time constant control 632. The period time over which averaging and other calculations are performed may be varied with such a control. A volume control 634 may be provided for varying the volume of the audio output of the variometer. An audio time constant control 636 may be included for varying the frequency of the audio output. A visual time constant control 638 may be included to vary the visual output of the variometer display 642. The speaker 640 may be used to provide audio data, instructions, warnings, and the like from the processor 610. The speaker 640 may be a built in speaker, an external speaker, a wireless speaker, headphones, earphones, wireless headphones, wireless earphones, and the like. Other inputs, outputs, controls, and other components may comprise or be attached to the variometer.

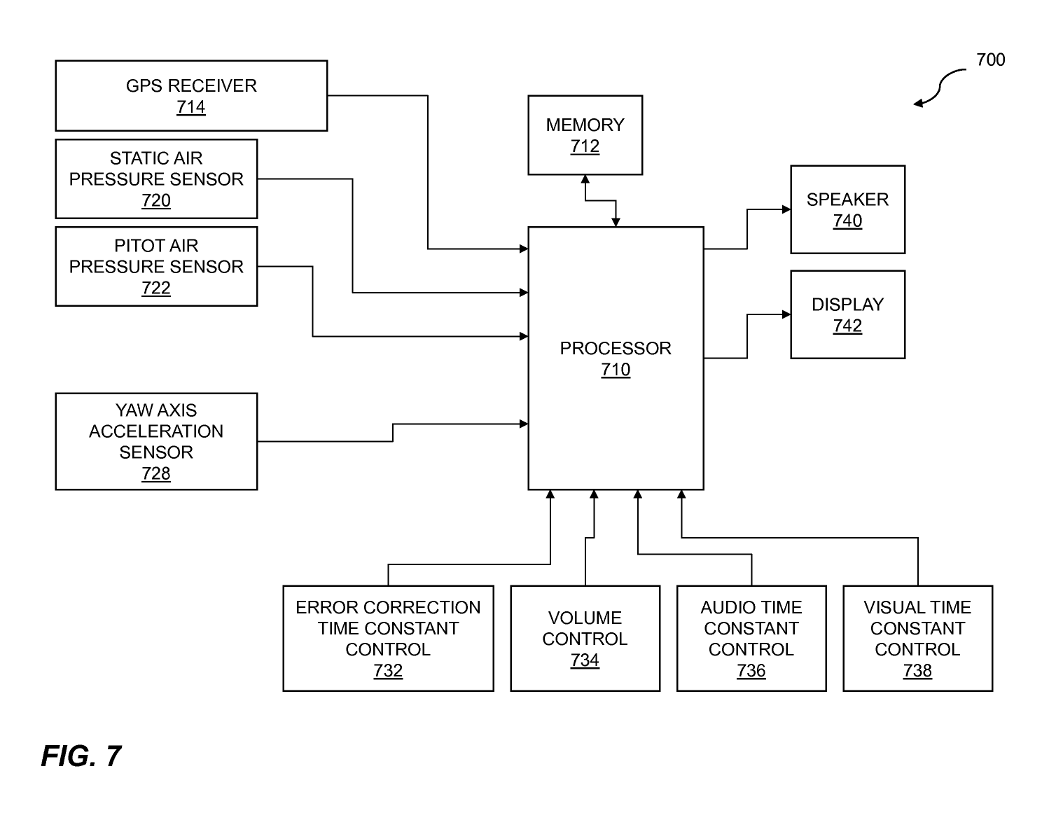

FIG. 7 is a system diagram for variometer using a GPS. FIG. 7 shows a system 700 for analyzing motion. The system 700 may include a processor 710 and a memory 712. The processor 710 may be one or more processors attached to the memory 712. The one or more processors 710 may execute instructions stored in the memory 712. The memory 712 may be used for storing instructions, for temporary data storage, for system support, and the like. The memory 712 may be comprised of one or more memories.

The system 700 may include a GPS receiver 714. The GPS receiver 714 may be used to determine altitude, direction, horizontal velocity, vertical velocity, and the like. The system 700 may include a static air pressure sensor 720 which is connected to the processor 710. The system 700 may include a pitot air pressure sensor 722. The system 700 may include a yaw axis acceleration sensor 728 where acceleration along the yaw axis 728 is measured using an accelerometer.

The system 700 may have various controls connected to the processor 710 that may include but are not limited to an error correction time constant control 732, a volume control 734, an audio time constant control 736, a visual time constant control 738, and the like. The system 700 may include a speaker 740. The speaker 740 may be a built in speaker, an external speaker, a wireless speaker, headphones, earphones, wireless headphones, wireless earphones, and the like. The system 700 may include a display 742. The display 742 may be used to provide output from the processor 710 including video data, instructions, graphical display, warnings, variometer readings, and the like. The display 742 may be an LCD display, a laptop display, a tablet display, a handheld display, a PDA display, or any other display technology, and the like.

The system 700 may include a means for determining a first altitude for an aircraft 720. A system 700 may include a means for calculating a potential energy for the aircraft based on the altitude. A system 700 may include a means for determining a horizontal velocity for the aircraft wherein the horizontal velocity is determined with a GPS receiver 714. A system 700 may include a means for compensating the horizontal velocity for the aircraft for wind speed wherein the wind speed is calculated using pitot pressure, to produce a compensated velocity. A system 700 may include a means for calculating a horizontal kinetic energy for the aircraft based on the compensated velocity. A system 700 may include a means for calculating a change in altitude based on air pressure. A system 700 may include a means for calculating an instantaneous vertical kinetic energy based on the change in altitude. A system 700 may include a means for calculating a total energy wherein the total energy is a sum of the horizontal kinetic energy, the instantaneous vertical kinetic energy, and the potential energy. Wind speed may be averaged over a period of time between 15 and 30 seconds. The altitude and the change in altitude of an aircraft may be based on one of a pressure and a GPS measurement. The velocity of the aircraft may be determined based on measured pitot air pressure 722 and static air pressure 720. The system 700 may include a means for calculating a total-energy compensated altitude-change rate based on the total energy. And, a system 700 may include a means for presenting the total-energy compensated altitude-change rate.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

What is claimed is:

1. A processor implemented method for analyzing motion comprising:
determining a first altitude for an aircraft;
calculating a potential energy for the aircraft based on the first altitude;
determining a velocity for the aircraft;
calculating a kinetic energy for the aircraft based on the velocity;
determining a first angle for the aircraft based on pointing direction of the aircraft relative to a pitch axis for the aircraft;
determining a second angle for the aircraft, relative to the pitch axis, such that when the first angle equals the second angle there is no transfer of energy between potential energy and kinetic energy; and
calculating a first altitude-change rate for the aircraft based on the velocity and a difference between the first angle and the second angle.

2. The method of claim 1 further comprising calculating a pitch-compensated altitude-change rate wherein the pitch-compensated altitude-change rate includes a difference between the first altitude-change rate and an altitude change rate based on changes in static pressure.

3. The method of claim 2 further comprising presenting the pitch-compensated altitude-change rate.

4. The method of claim 2 wherein the calculating of the pitch-compensated altitude-change rate is further based on an acceleration along a vertical axis of the aircraft.

5. The method of claim 4 wherein the acceleration is measured using an accelerometer.

6. The method of claim 1 wherein the velocity, used in the calculating of the first altitude-change rate, is modified to compensate for an exchange between the kinetic energy and the potential energy of the aircraft.

7. The method of claim 1 further comprising determining a total-energy compensated altitude-change rate based on a total energy for the aircraft.

8. The method of claim 7 further comprising averaging the total-energy compensated altitude-change rate to determine an average total-energy compensated altitude-change rate.

9. The method of claim 8 further comprising computing an average for the first altitude-change rate to provide an averaged value.

10. The method of claim 9 further comprising computing a difference between the average total-energy compensated altitude-change rate and the averaged value for the first altitude-change rate.

11. The method of claim 10 further comprising computing a correction to the second angle that minimizes the difference between the average total-energy compensated altitude-change rate and the averaged value for the first altitude-change rate.

12. The method of claim 11 wherein the correction is further based on an instantaneous lift coefficient.

13. The method of claim 1 wherein a measurement for the first altitude is based on measurement of static air pressure.

14. The method of claim 1 wherein the determining the second angle is based on a mass of the aircraft and an area of a wing on the aircraft.

15. The method of claim 1 further comprising calculating a total energy for the aircraft where the total energy is a sum of the potential energy and the kinetic energy.

16. The method of claim 15 further comprising calculating an average total energy over a period of time and using the average total energy in the determining of the second angle.

17. The method of claim 1 wherein the first altitude-change rate is corrected for a roll-axis bank angle of the aircraft.

18. The method of claim 1 wherein the first altitude-change rate is corrected for increased angle of attack due to aircraft rotational acceleration.

19. An apparatus for analyzing motion comprising:
a pressure sensor used in determining an altitude for an aircraft;
one or more sensors used in determining a velocity for the aircraft;
a pitch angle sensor for determining a first angle for the aircraft; and
one or more processors that:
calculate a kinetic energy for the aircraft based on the velocity;
calculate a potential energy for the aircraft based on the altitude;
determine a second angle for the aircraft, relative to pitch axis, such that when the first angle equals the second angle there is no transfer of energy between potential energy and kinetic energy; and
calculate a first altitude-change rate for the aircraft based on the velocity and a difference between the first angle and the second angle.

20. A computer program product embodied in a non-transitory computer readable medium for analyzing motion, the computer program product comprising:
code for determining a first altitude for an aircraft;
code for calculating a potential energy for the aircraft based on the first altitude;
code for determining a velocity for the aircraft;
code for calculating a kinetic energy for the aircraft based on the velocity;
code for determining a first angle for the aircraft based on pointing direction of the aircraft relative to a pitch axis for the aircraft;
code for determining a second angle for the aircraft, relative to the pitch axis, such that when the first angle equals the second angle there is no transfer of energy between potential energy and kinetic energy; and
code for calculating a first altitude-change rate for the aircraft based on the velocity and a difference between the first angle and the second angle.
